(19) United States
(12) Patent Application Publication
(10) Pub. No.: US 2013/0062934 A1
(43) Pub. Date: Mar. 14, 2013

(54) MECHANICAL ATTENUATOR FOR A VEHICLE BRAKING SYSTEM

(71) Applicant: Naseem Daher, Lafayette, IN (US)

(72) Inventor: Naseem Daher, Lafayette, IN (US)

(73) Assignee: Kelsey-Hayes Company, Livonia, MI (US)

(21) Appl. No.: 13/231,489

(22) Filed: Sep. 13, 2011

(51) Int. Cl. B60T 17/04; B60T 15/00; B60T 13/16

(52) U.S. Cl. 303/10; 303/87

(57) ABSTRACT

An attenuator assembly for use in a vehicle braking system includes a rigid tube disposed within a bore of a hydraulic control unit (HCU) for reduced HCU package size. An attenuator is disposed in the rigid tube and includes a metallic biasing member.

### BACKGROUND

Various embodiments of an attenuator are described herein. In particular, the embodiments described herein are mounted in a hydraulic control unit of an electronically controlled brake system.

Devices for autonomously generating brake pressure have been a part of the prior art since the introduction of driver assistance functions, such as, for example, a vehicle stability control (VSC). Autonomously generating brake pressure makes it possible to brake individual wheels or all wheels of the vehicle independently of the driver actuating the brake. Additional driver assistance functions beyond the safety-related VSC have been developed for safety as well as comfort functions, such as for example adaptive cruise control (ACC).

When the ACC function is activated, the distance and relative speed of a vehicle traveling up ahead is recorded by laser distance sensors or preferably radar distance sensors. The ACC function maintains a speed selected by the driver until a slower vehicle traveling up ahead is identified and a safe distance from it is no longer being maintained. In this case, the ACC function engages by braking to a limited extent and, if needed, by subsequent acceleration in order to maintain a defined spatial or temporal distance from the vehicle traveling up ahead. Additional ACC functions are expanded to the extent of also braking the vehicle to a stop. This is used for example in the case of a so-called follow-to-stop function or a function to minimize the occurrence of a collision.

Further developments also permit a so-called stop-and-go function, wherein the vehicle also starts automatically if the vehicle up ahead is set in motion again. To do so, the stop-and-go function typically executes a frequently changing autonomous pressure build-up to approximately 30 to 40 bar in the vehicle braking system independent of the generation of brake pressure originating from the driver. In the case of typical speeds on freeways, an autonomous deceleration is often restricted to approximately 0.2 g. At lower speeds, however, the system can generate an autonomous deceleration of 0.6 g for example. A further development also includes an automatic emergency brake (AEB), whereby the AEB function detects potential accident situations in due time, warns the driver, and initiates measures to autonomously brake the vehicle with full force. In this case, rapid brake pressure build-up rates may occur.

Devices for autonomously generating brake pressure include pumps, such as piston pumps. In particular, the conveyance of brake fluid through piston pumps generates pulsations, which can spread audibly via brake circuits and also affect the noise level in the vehicle's interior. To dampen noise or pulsations, devices for autonomously generating brake pressure are known that feature an attenuator or an orifice on the outlet side of the pump.

The use of attenuators, which reduce amplitude of pressure fluctuations in hydraulic fluid lines of vehicular braking systems, is well known. In particular, attenuators are common in vehicular anti-lock braking systems (ABS) at the outlet end of an ABS hydraulic pump used to evacuate a low pressure accumulator. A hydraulic control unit (HCU) includes a housing having bores for mounting valves and the like and channels for directing fluid. An attenuator may be mounted in a bore in the HCU to significantly reduce the amplitude of high energy pressure pulses in the brake fluid at the outlet of the pump. These pressure pulses can create undesirable noise, which is transmitted to the master cylinder or its connection to the vehicle. These pressure pulses can also cause undesirable brake pedal vibrations.

A typical attenuator includes a chamber filled with brake fluid. An inlet passage delivers fluid from the outlet end of the pump to the chamber, and an orifice of substantially reduced diameter directs fluid from the chamber to an outlet passage. The restriction of fluid flow through the orifice attenuates pressure fluctuations as a result of the compressibility of the brake fluid. Thus, brake fluid in the chamber absorbs high energy fluid pulses and slowly releases the fluid through the orifice.

U.S. Pat. No. 5,540,486 shows, in FIG. 1 for example, a pump 24 with an attenuator 26 arranged downstream from the pump 24, and an orifice 28. The attenuator 26 includes an elastomer core piece 410′. The core piece 410′ includes an annular seal 66′ at the head end 412′ of the attenuator and an axially extending compression rib 52′.

Printed document WO 02/14130 A1 shows a vehicle braking system, which comprises a device for autonomously generating brake pressure with a pump 8, a compensating tank 48 arranged downstream from the pump 8 and a throttle 49. By using the throttle, pump noises are dampened and an improvement in comfort is achieved. The throttle, however, has a limiting effect on pressure build-up rates.

Another known attenuator for use in an ABS system is disclosed in U.S. Pat. No. 5,921,636 to Roberts. The attenuator 70 includes a cylinder 72 slideably received in a bore 73 of the housing 400. An elastomeric plug 80 is received in and fills a substantial volume of a bore or chamber 75 of the cylinder 72. The volume of the interior chamber 75 not filled by the core piece 80 provides a streamlined path for fluid flowing through attenuator 70. This streamlined path substantially eliminates fluid turbulence typically found in reservoirs of known attenuators due to a relatively large volume of air entering the reservoirs from aeration of the brake fluid.

German Patent Application DE 10 2009 006 980 A1 shows an attenuator 7 in an HCU of a brake system. The attenuator 7 includes an attenuation chamber 8 having a fixed orifice 9 and a switchable orifice 10. The fixed orifice 9 is about twice as large as the switchable orifice 10. The switching function of the switchable orifice 10 is performed by a ball-check valve 11. The ball-check valve 11 is controlled by differential pressure and is configured to open at a predetermined cracking pressure. If the pressure difference at the ball-check valve 11 is not sufficient to open the ball-check valve 11, then fluid will flow initially through the switchable orifice 10, then through the fixed orifice 9 with the relatively larger orifice opening. When the pressure difference on the ball-check valve 11 reaches the predetermined cracking pressure, the ball 13 will lift up from its valve seat 14 so that the pulsating flow rate/volumetric flow moves directly from the attenuation chamber 8 through the orifice 9 with a large orifice opening. The ball-check valve 11 prevents fluid flow back through the orifice 9 to the attenuation chamber 8. Additionally, the ball 13 of the ball-check valve 11 operates in one of two positions: (1) a closed position when the pressure difference at the ball-check valve 11 is not sufficient to move the ball 13 against the force of the spring, and (2) a fully open position when the pressure difference on the ball-check valve 11 reaches the predetermined cracking pressure, and the ball 13 is lifted up from its valve seat 14 to allow fluid to flow through the ball-check valve 11.

There remains a need for an improved attenuator to dampen the vibrations and pressure pulses that occur in vehicular anti-lock braking systems.

### SUMMARY

The present application describes various embodiments of a vehicle braking system. In one embodiment, an attenuator assembly for use in a vehicle braking system includes a rigid tube disposed within a bore of a hydraulic control unit (HCU) for reduced HCU package size. An attenuator is disposed in the rigid tube and includes a metallic biasing member.

In another embodiment, a vehicle braking system is operable to automatically and selectively apply the brakes in an attempt to stabilize the vehicle when an instability condition has been sensed. The vehicle braking system includes a variable speed motor driven piston pump for supplying pressurized fluid pressure to the brakes through a valve arrangement and an attenuator connected to a pump outlet for dampening pump output pressure pulses prior to application to the brakes. The vehicle braking system includes a rigid tube disposed within a bore of a hydraulic control unit (HCU) for reduced HCU package size. The attenuator is disposed in the rigid tube and includes a metallic biasing member.

In a further embodiment an attenuator assembly for use in a vehicle braking system includes a rigid tube disposed within a bore of a hydraulic control unit (HCU) for reduced HCU package size. An attenuator is disposed in the rigid tube and includes a metallic biasing member. A retainer is disposed in the bore of the HCU, a portion of the retainer engaging an inside surface of the rigid tube. A piston is slideably mounted within a bore of the retainer. A first end of the piston engages the biasing member. A second end of the piston and a closed end of the bore of the retainer define a retainer chamber.

Other advantages of the vehicle braking system will become apparent to those skilled in the art from the following detailed description, when read in light of the accompanying drawings.

### BRIEF DESCRIPTION OF THE DRAWINGS

FIG. 1 is a hydraulic circuit diagram of a vehicle braking system with an attenuator assembly according to the invention.

FIG. 2 is an enlarged cross sectional view of a first embodiment of the attenuator assembly illustrated in FIG. 1.

FIG. 3 is an enlarged cross sectional view of a second embodiment of the attenuator assembly.

### DETAILED DESCRIPTION

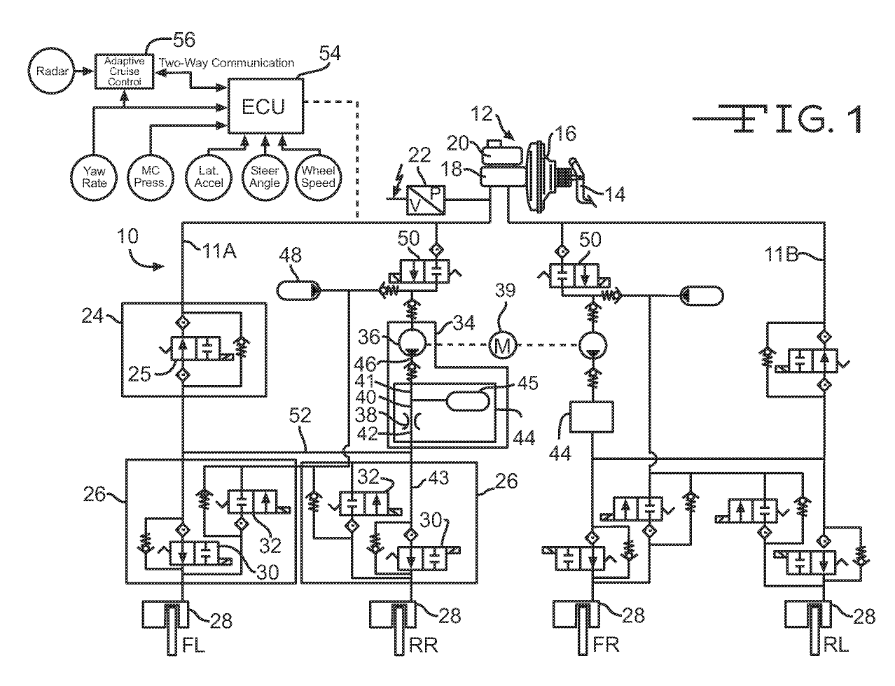

A hydraulic vehicle braking system is indicated generally at 10 in FIG. 1. The illustrated embodiment of the vehicle brake system 10 includes valves and other components described below to provide an electronic stability control (ESC) capability. The vehicle braking system 10 includes a slip control system operable in an ESC mode to automatically and selectively apply the brakes in an attempt to stabilize the vehicle when an instability condition has been sensed by any of the sensors providing data to an electronic control unit (ECU) 54. The vehicle brake system 10 is intended to be exemplary and it will be appreciated that there are other brake control system configurations that may be used to implement the various valve embodiments described herein. In other embodiments, the brake system 10 may include components to provide anti-lock braking, traction control, and/or vehicle stability control functions.

The slip control system is further operable in an adaptive cruise control (ACC) mode to automatically apply the brakes to slow the vehicle in response to a control signal, as shown in FIG. 1. The slip control system includes a variable speed motor driven piston pump 36, described below, for supplying pressurized fluid pressure to brake cylinders 28 of the brakes through a valve arrangement. In the ESC mode, a pump motor 39 operates in an ESC speed range with a relatively higher flow rate. In the ACC mode, the pump motor 39 operates in an ACC speed range. The ACC speed range and flow rate are lower than the ESC speed range and flow rate, respectively. The slip control system further includes an attenuator assembly 44 connected to a pump outlet 46 for dampening pump output pressure pulses prior to application to the brakes.

The vehicle brake system 10 has two separate brake circuits 11A and 11B, respectively, which are depicted on the left and right halves of FIG. 1. In the exemplary embodiment illustrated in FIG. 1, the circuits 11A and 11B supply brake pressure to front and rear wheel brakes. The illustrated rear wheel brake is arranged diagonally to the front wheel brake. Only the left brake circuit 11A in FIG. 1 is described in the following in more detail. However, the right brake circuit 11B in FIG. 1 can be structured in the same manner.

The brake system 10 includes a driver-controlled first pressure generating unit 12 with a brake pedal 14, a power brake unit 16, and a tandem master brake cylinder 18 which presses the brake fluid out of a reservoir 20 into the two brake circuits 11A and 11B. Arranged behind an outlet of the tandem master brake cylinder 18 is a pressure sensor 22 for detecting the driver's input.

Under normal driving conditions, brake fluid pressure emanating from the driver-controlled first pressure generating unit 12 continues via a block valve arrangement 24 and a pair of anti-lock brake system (ABS) valve arrangements 26 to the front left (FL) and rear right (RR) wheel brake cylinders 28. Each of the ABS valve arrangements 26 includes an ABS inlet or isolation valve 30 and an ABS discharge or dump valve 32. The ABS inlet valve 30 is normally open, and the ABS discharge valve 32 is normally closed. Each wheel brake cylinder 28 includes an ABS valve arrangement 26, and the brake fluid pressure of both brake circuits is distributed diagonally in the vehicle to a respective pair of wheel brake cylinders 28, the FL and RR, or the front right (FR) and rear left (RL), respectively. The illustrated block valve arrangement 24 is part of a traction control or vehicle stability control system and includes an isolation valve 25 that is normally open in a currentless state. In a current-carrying state, the block valve arrangement 24 is blocked from a backflow of brake fluid from the wheel brake cylinders 28 to the master brake cylinder 18.

Brake fluid pressure may be built up independently of the driver-controlled first pressure generating unit 12 by an autonomous second pressure generating unit 34. The autonomous second pressure generating unit 34 includes the pump 36 driven by the pump motor 39 and the attenuator assembly 44. The attenuator assembly 44 includes an attenuator 45 and an orifice 38. The orifice 38 has an inlet side 40 and an outlet side 42. The orifice 38 may be any desired orifice, such as the two-stage orifice disclosed in commonly assigned International Patent Application No. PCT/US2010/045159, filed Aug. 11, 2010, and which is incorporated herein by reference. The attenuator assembly 44 is in fluid communication with a pump outlet 46 via a conduit 41 and a conduit 43 via the orifice 38. Pulsations emanating from the pump 36 are periodic fluctuations in the brake fluid flow. The attenuator assembly 44 takes in brake fluid during the pulsation peaks and releases it again between the pulsation peaks. As a result, the attenuator 44 levels out a temporal pressure progression on the inlet side 40 of the orifice 38.

Arranged on the intake side of the pump 36 are a low pressure accumulator (LPA) 48 and a pump inlet or supply valve 50. The illustrated pump inlet valve 50 is a normally closed valve. When the pump inlet valve 50 is currentless and closed, the pump 36 is supplied with brake fluid from the LPA 48. When the pump inlet valve 50 is current-carrying and open, the pump 36 can also suction brake fluid from the master brake cylinder 18.

The driver-controlled first pressure generating unit 12 and the autonomous second pressure generating unit 34 convey brake fluid in a common brake branch 52 of one of the two brake circuits. As a result, both pressure generating units 12, 34 can build up brake fluid pressure to the wheel brake cylinders 28 of the brake circuit independently of one another.

The vehicle brake system 10 uses the autonomous second pressure generating unit 34 for generating brake pressure within the scope of a vehicle stability control (VSC function). Moreover, the autonomous second pressure generating unit 34 can also be used for the adaptive cruise control (ACC function). In the process, the autonomous second pressure generating unit 34 can build up brake fluid pressure for autonomously braking the vehicle in the course of a stop-and-go function in frequent succession and not just in extraordinary, relatively rare driving situations. This also occurs with predominantly low to moderate driving speeds, at which the basic noise level in the vehicle interior is relatively low. Under such conditions, known pressure generating units represent a source of noise and pulsation that can be annoying in terms of driving comfort.

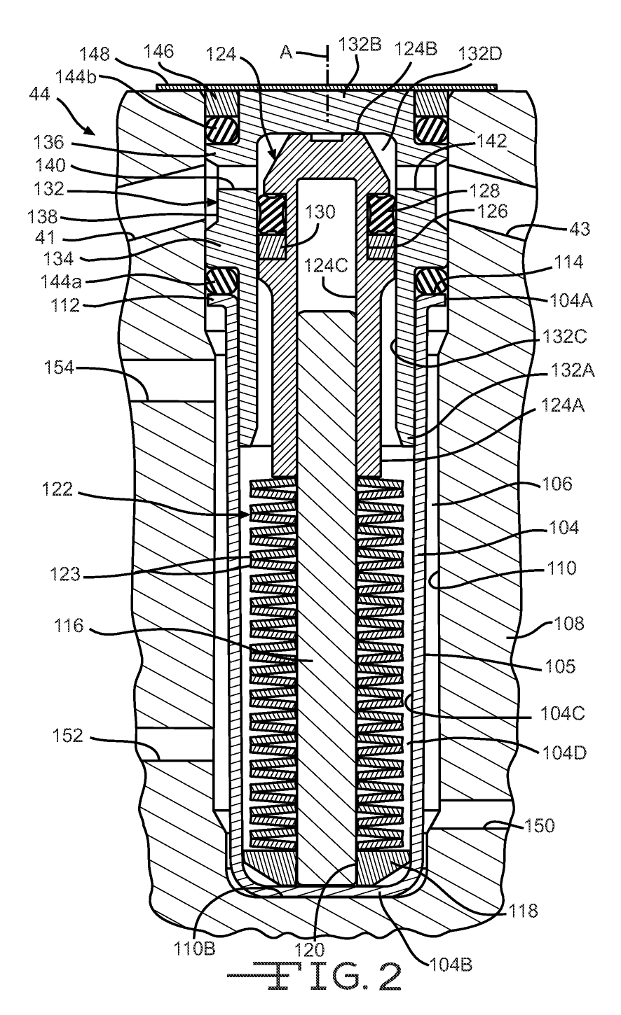

It will be understood that the vehicle brake system 10 may include a hydraulic control unit (HCU) (not shown in FIG. 1) connected in fluid communication between the master brake cylinder 18 and wheel brake cylinders 28. As best shown in FIG. 2 and described in detail below, the HCU typically includes a hydraulic valve block or housing containing the various control valves and other components described herein for selectively controlling hydraulic brake pressure at the wheel brake cylinders 28.

As shown at 54 in FIG. 1, the vehicle brake system 10 may include an electronic control unit (ECU) which receives input signals from sensors, such as yaw rate, master cylinder pressure, lateral acceleration, steer angle, and wheel speed sensors. The ECU may also receive ground speed data from an ACC system 56. The ACC system may receive input data from a radar and the vehicle yaw rate sensor. One example of a vehicular control system adapted to control fluid pressure in an electronically-controlled vehicular braking system and an electronically-controlled ACC system is disclosed in commonly assigned U.S. Pat. No. 6,304,808 to Milot, which is incorporated herein by reference in its entirety.

Referring now to FIG. 2, there is illustrated a first embodiment of the attenuator assembly 44. In the illustrated embodiment, the attenuator assembly 44 includes a rigid tube 104 disposed within a chamber or bore 110 in a housing or valve body, a portion of which is shown at 108. An outer surface 105 of the tube 104 also serves as one side (an inside surface) of an annular fluid passage 106 for fluid flow within the valve body 108. In the illustrated embodiment, the valve body 108 is an HCU. The other side (an outside surface) of the annular passage 106 is defined by the bore 110 in the valve body 108 that contains the attenuator assembly 44. The bore 110 has an axis A and may have more than one inside diameter.

The tube 104 is a substantially rigid member having a first axial end or open end 104A, a second axial end or closed end 104B, and an outside diameter smaller than an inner diameter of the bore 110. In the embodiment illustrated in FIG. 2, an inside surface 104C of the tube 104 defines an attenuator chamber 104D. The open end 104A includes a radially outward extending flange 112 that further defines a shoulder 114. The tube 104 is coaxially mounted within the bore 110 such that the closed end 104B of the tube 104 engages a closed end 110B of the bore 110.

An elongated guide member 116 is coaxially mounted within the tube 104. In the illustrated embodiment, the guide member 116 is substantially cylindrical. Alternatively, the guide member 116 may have other cross sectional shapes, such as square, hexagonal, octagonal, and other shapes. The illustrated guide member 116 is formed from steel. Alternatively, the guide member 116 may also be formed from other substantially rigid metals, metal alloys, and non-metals.

A guide seat 118 is seated against the closed end 104B of the tube 104. In the illustrated embodiment, the guide seat 118 is an annular member having a substantially cylindrical outer surface and a centrally formed opening 120. One end of the guide member 116 is mounted within the opening 120. Alternatively, the outer surface of the guide seat 118 may have other shapes, such as square, hexagonal, octagonal, and other shapes. The illustrated guide member 116 is formed from stainless steel. Alternatively, the guide member 116 may also be formed from steel, and from other substantially rigid metals, metal alloys, and non-metals.

A biasing member 122 is disposed about the guide member 116 between the guide seat 118 and the piston 124. In the illustrated embodiment, the biasing member 122 is a plurality of metallic disc springs 123, such as Belleville washers. Specifically, the illustrated biasing member 122 is an assembly comprising a plurality of pairs of Belleville washers 123.

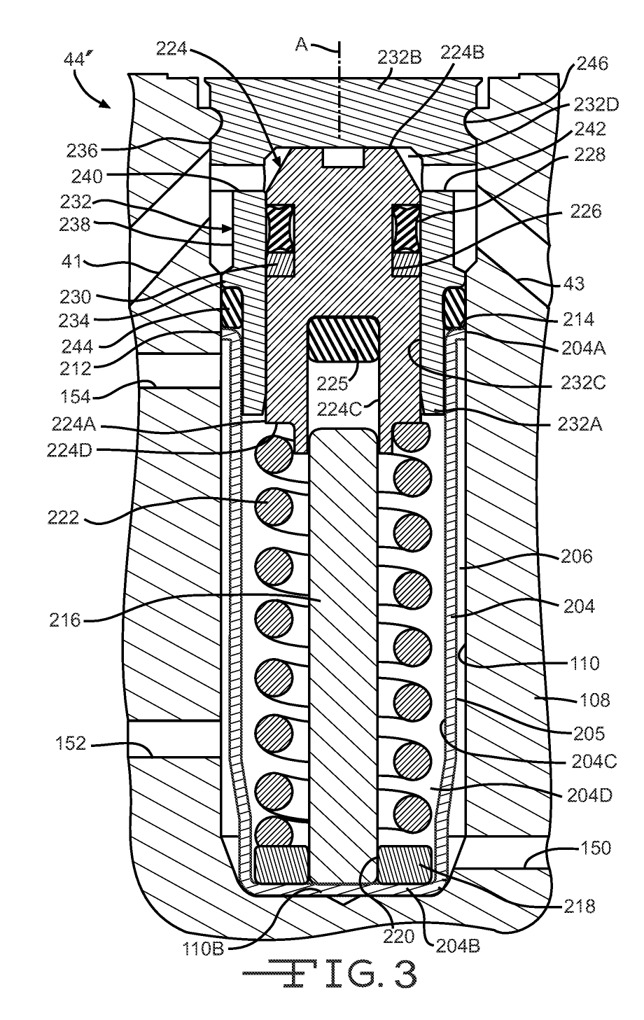

A piston 124 has a first axial or open end 124A and a second axial or closed end 124B. The closed end 124B has a substantially frusto-conical shape. An axially extending and substantially cylindrical bore 124C is centrally formed in the piston 124. A circumferential groove 126 is formed near the second end 124B and defines a seal seat. The illustrated piston 124 is formed from stainless steel. Alternatively, the piston 124 may also be formed from steel, and from other substantially rigid metals, metal alloys, and non-metals. If desired, an elastomeric member, such as the elastomeric member 225 illustrated in FIG. 3, may be mounted at a base of the piston bore 124C and define a bumper for engaging the guide member 116. The purpose and function of the elastomeric member 225 are described below.

An annular seal 128 is disposed about the piston 124 within the groove 126. In the illustrated embodiment, the seal 128 is a quad seal formed from an elastomeric material. Alternatively, the seal 128 may be other types of seals, such as an O-ring, and may be formed from any desired material. A first back-up seal 130 is also disposed about the piston 124 within the groove 126 between the seal 128 and the first end of the piston 124. In the illustrated embodiment, the back-up seal 130 is an annular member formed from steel, or steel coated with a non-stick coating such as TEFLON®. Alternatively, the back-up seal 130 may be formed from any other desired material, and may be coated with other desired non-stick coatings.

A retainer 132 has a first axial or open end 132A and a second axial or closed end 132B. An axially extending and substantially cylindrical retainer bore 132C is centrally formed in the retainer 132. The bore 132C defines a retainer chamber 132D. First and second radially outward extending flanges 134 and 136, respectively are axially spaced apart and define a circumferential groove 138. A first conduit 140 is formed between the circumferential groove 138 and the retainer chamber 132D and defines a fluid inlet. A second conduit 142 is formed between the circumferential groove 138 and the retainer chamber 132D at about 180 degrees from the first conduit 140 and defines a fluid outlet. The first conduit 140 communicates with the conduit 41. The second conduit 142 communicates with the conduit 43 to the inlet side 40 of the orifice 38. Brake fluid may flow from the pump 36, through the first conduit 140, retainer chamber 132D, and second conduit 142, to the two-stage orifice 38. The illustrated retainer 132 is formed from stainless steel. Alternatively, the retainer 132 may also be formed from steel, and from other substantially rigid metals, metal alloys, and non-metals.

The piston 124 is slideably mounted within the retainer bore 132C such that the guide member 116 is also slideably mounted within the piston bore 124C, and the first end 124A of the piston 124 engages the biasing member 122.

A first sealing member 144a is disposed between the shoulder 114 of the tube 104 and the first flange 134. In the illustrated embodiment, the first sealing member 144a is an elastomeric O-ring. A similar second sealing member 144b is disposed between the second flange 136 and an open end of the bore 110. The O-ring 144b is urged against the second flange 136 by a second back-up seal 146. The attenuator assembly 44 may be retained within the bore 110 by a closing member 148. In the illustrated embodiment, the closing member 148 is a plate formed from steel and welded to the valve body 108. Alternatively, the closing member 148 may also be formed from other substantially rigid metals, metal alloys, and non-metals.

An inlet passageway 150 is formed in the valve body 108 and allows fluid flow between the two-stage orifice 38 and the annular fluid flow passage 106. First and second outlet passageways 152 and 154 are also formed in the valve body 108. The outlet passageways 152 and 154 allow fluid flow between the annular fluid flow passage 106 and valves, such as the ABS inlet valves 30.

Advantageously, the illustrated embodiment of the attenuator assembly 44 allows the valve body 108 to have a reduced or relatively small package size when used with a conventional Electronic Stability Control (ESC) hydraulic circuit.

In operation, during a compression stroke of the pistons within the piston pump 36, fluid flows from the piston pump 36 through the conduit 41 and the fluid inlet 140 into the retainer chamber 132D and to the brakes FL and RR via the orifice 38. In the retainer chamber 132D, the fluid urges the piston 124 against the biasing member 122 (downwardly when viewing FIG. 2), thereby compressing the biasing member 122 and fills the chamber 132D. From the orifice 38, fluid may flow to the isolation valve 25, back through the annular fluid passage 106, and through the outlet passageways 152 and 154 to the ABS inlet valves 30, such as the front left and rear right inlet valves 30 illustrated in FIG. 1. During a return stroke of the pistons within the piston pump 36, the biasing member 122 returns to a pre-load condition, as shown in FIG. 2.

During the compression stroke of the pistons within the piston pump 36, energy is stored in the chamber 132D. The amplitude of the pulsations in the brake fluid flow emanating from the pump 36 are reduced in intensity or dampened within the volume of fluid in the chamber 132D. The reduced amplitude of the pressure pulsations results in the pulsations being felt less at the brake pedal and/or the steering wheel.

Referring now to FIG. 3, there is illustrated a second embodiment of the attenuator assembly 44′. In the illustrated embodiment, the attenuator assembly 44′ includes a rigid tube 204 disposed within the chamber or bore 110 of the valve body 108. An outer surface 205 of the tube 204 serves as one side (an inside surface) of an annular fluid passage 206 for fluid flow within the valve body 108. The other side (an outside surface) of the annular passage 206 is defined by the bore 110 in the valve body 108 that contains the attenuator assembly 44′. The bore 110 has an axis A and may have more than one inside diameter.

The tube 204 is a substantially rigid member having a first axial end or open end 204A, a second axial end or closed end 204B, and an outside diameter smaller than an inner diameter of the bore 110. In the embodiment illustrated in FIG. 3, an inside surface 204C of the tube 204 defines an attenuator chamber 204D. The open end 204A includes a radially outward extending flange 212 that further defines a shoulder 214. The tube 204 is coaxially mounted within the bore 110 such that the closed end 204B of the tube 204 engages a closed end 110B of the bore 110.

An elongated guide member 216 is coaxially mounted within the tube 204. In the illustrated embodiment, the guide member 216 is substantially cylindrical. Alternatively, the guide member 216 may have other cross sectional shapes, such as square, hexagonal, octagonal, and other shapes. The illustrated guide member 216 is formed from steel. Alternatively, the guide member 116 may also be formed from other substantially rigid metals, metal alloys, and non-metals.

A guide seat 218 is seated against the closed end 204B of the tube 204. In the illustrated embodiment, the guide seat 218 is an annular member having a substantially cylindrical outer surface and a centrally formed opening 220. One end of the guide member 216 is mounted within the opening 220. Alternatively, the outer surface of the guide seat 218 may have other shapes, such as square, hexagonal, octagonal, and other shapes. The illustrated guide member 216 is formed from stainless steel. Alternatively, the guide member 216 may also be formed from steel and from other substantially rigid metals, metal alloys, and non-metals.

A biasing member 222 is disposed about the guide member 216 between the guide seat 218 and the piston 224. In the illustrated embodiment, the biasing member 222 is a metallic coil spring.

A piston 224 has a first axial or open end 224A and a second axial or closed end 224B. The closed end 224B has a substantially frusto-conical shape. An axially extending and substantially cylindrical bore 224C is centrally formed in the piston 224. A circumferential groove 226 is formed near the second end 224B and defines a seal seat. The open end 224A includes a circumferentially extending stepped portion 224D defining a spring seat. The illustrated piston 224 is formed from stainless steel. Alternatively, the piston 224 may also be formed from steel and from other substantially rigid metals, metal alloys, and non-metals. An elastomeric member 225 is mounted at a base of the piston bore 224C and defines a bumper for engaging the guide member 216.

An annular seal 228 is disposed about the piston 224 within the groove 226. In the illustrated embodiment, the seal 228 is a quad seal formed from an elastomeric material. Alternatively, the seal 228 may be other types of seals, such as an O-ring, and may be formed from any desired material. A back-up seal 230 is also disposed about the piston 224 within the groove 226 between the seal 228 and the first end of the piston 224. In the illustrated embodiment, the back-up seal 230 is an annular member formed from steel or steel coated with a non-stick coating such as TEFLON®. Alternatively, the back-up seal 230 may be formed from any other desired material, and may be coated with other desired non-stick coatings.

A retainer 232 has a first axial or open end 232A and a second axial or closed end 232B. An axially extending and substantially cylindrical retainer bore 232C is centrally formed in the retainer 232. The bore 232C defines a retainer chamber 232D. First and second radially outward extending flanges 234 and 236, respectively are axially spaced apart and define a circumferential groove 238. A first conduit 240 is formed between the circumferential groove 238 and the retainer chamber 232D and defines a fluid inlet. A second conduit 242 is formed between the circumferential groove 238 and the retainer chamber 232D at about 180 degrees from the first conduit 240 and defines a fluid outlet. The first conduit 240 communicates with the conduit 41. The second conduit 242 communicates with the conduit 43 to the inlet side 40 of the orifice 38. Brake fluid may flow from the pump 36, through the first conduit 240, retainer chamber 232D, and second conduit 242, to the two-stage orifice 38. The illustrated retainer 232 is formed from stainless steel. Alternatively, the retainer 232 may also be formed from steel and from other substantially rigid metals, metal alloys, and non-metals.

The piston 224 is slideably mounted within the retainer bore 232C such that the guide member 216 is also slideably mounted within the piston bore 224, and the first end 224A of the piston 224 engages the biasing member 222.

An O-ring 244 is disposed between the shoulder 214 of the tube 204 and the first flange 234. A circumferential clinching groove 246 is formed in the outer surface at the closed end 232B of the retainer 232. The attenuator assembly 44′ may be retained within the bore 110 by clinching, wherein material of the valve body 108 is forced into the groove 236. The attenuator assembly 44′ may also be retained in the bore 110 by any desired mechanical or chemical means operative to retain the attenuator assembly 44′ within the bore 110.

As described above, the inlet passageway 150 is formed in the valve body 108 and allows fluid flow between the two-stage orifice 38 and the annular fluid flow passage 106. The first and second outlet passageways 152 and 154 are also formed in the valve body 108. The outlet passageways 152 and 154 allow fluid flow between the annular fluid flow passage 106 and valves, such as the ABS inlet valves 30.

Advantageously, the attenuator assemblies 44 and 44′ having metal biasing members; i.e., the disc springs 123 and the spring 222, respectively, have a higher dynamic response, and improved noise, vibration, and harshness (NVH) performance relative to similar attenuators with elastomeric members in the fluid chamber. Further, the metal biasing members experience less performance variation due to temperature changes relative to elastomeric members.

As a further advantage, the attenuator assembly 44′ may function as a dual stage attenuator. A first stage occurs as the piston 224 slides onto the guide member 216 in response to relatively low pressure, such as pressure below about 60 bar, moving the guide member 216 into contact with the elastomeric member 225 and filling the retainer chamber 232D with fluid. A second stage occurs as the piston 224 urges the elastomeric member 225 against the guide member 216 in response to relatively higher pressure, such as pressure above about 60 bar. Any additional change in fluid volume in the retainer bore 232C is very small and increases as a function of the compressibility of the elastomeric member 225.

Additionally, the elastomeric member 225 significantly reduces or eliminates any noise, such as clanging noise that may result from the sliding piston 224 contacting the guide member 216 at the base of the piston bore 224C.

The principle and mode of operation of the attenuator have been described in its preferred embodiment. However, it should be noted that the attenuator described herein may be practiced otherwise than as specifically illustrated and described without departing from its scope.

What is claimed is:

1. An attenuator assembly for use in a vehicle braking system comprising:
a rigid tube disposed within a bore of a hydraulic control unit (HCU) for reduced HCU package size; and
an attenuator disposed in the rigid tube, the attenuator including a metallic biasing member.

2. The attenuator assembly according to claim 1, wherein the biasing member includes a plurality of disc springs.

3. The attenuator assembly according to claim 1, wherein the biasing member includes a coil spring.

4. The attenuator assembly according to claim 1, wherein the rigid tube includes a radially outward extending flange at an open end of the rigid tube, an outer circumferential surface of the flange engaging a wall of the bore of the HCU.

5. The attenuator assembly according to claim 1, further including a retainer in the bore of the HCU, a portion of the retainer engaging an inside surface of the rigid tube, and a portion of the retainer engaging the flange of the rigid tube.

6. The attenuator assembly according to claim 5, further including a sealing member disposed between the flange of the rigid tube and the retainer.

7. The attenuator assembly according to claim 5, further including a piston slideably mounted within a bore of the retainer, the piston engaging the biasing member.

8. The attenuator assembly according to claim 7, wherein the retainer includes a first conduit defining a fluid inlet flow path to the bore of the retainer.

9. The attenuator assembly according to claim 8, wherein the retainer includes a second conduit defining a fluid outlet flow path from the bore of the retainer.

10. The attenuator assembly according to claim 1, wherein an annular space is defined between an outer surface of the rigid tube and a wall of the bore of the HCU, the annular space defining an annular fluid flow passage for fluid flow within the HCU.

11. A vehicle braking system operable to automatically and selectively apply the brakes in an attempt to stabilize the vehicle when an instability condition has been sensed, the vehicle braking system including a variable speed motor driven piston pump for supplying pressurized fluid pressure to the brakes through a valve arrangement, the vehicle braking system further including an attenuator connected to a pump outlet for dampening pump output pressure pulses prior to application to the brakes, the vehicle braking system comprising a rigid tube disposed within a bore of a hydraulic control unit (HCU) for reduced HCU package size, wherein the attenuator is disposed in the rigid tube and includes a metallic biasing member.

12. The vehicle braking system according to claim 11, wherein the biasing member includes a plurality of disc springs.

13. The vehicle braking system according to claim 11, wherein the biasing member includes a coil spring.

14. The vehicle braking system according to claim 11, wherein the rigid tube includes a radially outward extending flange at an open end of the rigid tube, an outer circumferential surface of the flange engaging a wall of the bore of the HCU.

15. The vehicle braking system according to claim 11, further including a retainer in the bore of the HCU, a portion of the retainer engaging an inside surface of the rigid tube, and a portion of the retainer engaging the flange of the rigid tube.

16. The vehicle braking system according to claim 15, further including a piston slideably mounted within a bore of the retainer, the piston engaging the biasing member.

17. The vehicle braking system according to claim 15, wherein the retainer includes a first conduit defining a fluid flow path from the piston pump to the bore of the retainer.

18. The vehicle braking system according to claim 17, wherein the retainer includes a second conduit defining a fluid flow path from the bore of the retainer to an orifice.

19. The vehicle braking system according to claim 11, wherein an annular space is defined between an outer surface of the rigid tube and a wall of the bore of the HCU, the annular space defining an annular fluid flow passage for fluid flow within the HCU.

20. An attenuator assembly for use in a vehicle braking system comprising:
a rigid tube disposed within a bore of a hydraulic control unit (HCU) for reduced HCU package size;
an attenuator disposed in the rigid tube, the attenuator including a metallic biasing member;
a retainer disposed in the bore of the HCU, a portion of the retainer engaging an inside surface of the rigid tube; and
a piston slideably mounted within a bore of the retainer, a first end of the piston engaging the biasing member, a second end of the piston and a closed end of the bore of the retainer defining a retainer chamber.
